(19) United States
(12) Patent Application Publication
(10) Pub. No.: US 2018/0128141 A1
(43) Pub. Date: May 10, 2018

(54) Pressure Relief Device For Tank

(71) Applicant: GM GLOBAL TECHNOLOGY OPERATIONS LLC, Detroit, MI (US)

(72) Inventors: Yong Pan, Markham (CA); Aleksandar Filipovski, Oshawa (CA); Biljana Rajic, Whitby (CA)

(21) Appl. No.: 15/347,051

(22) Filed: Nov. 9, 2016

(51) Int. Cl. F01N 3/20; F16K 17/02; B60K 15/035

(52) U.S. Cl. CPC F01N 3/206; F16K 17/02; B60K 2015/03561; F01N 2610/1406; F01N 2610/1433; B60K 15/035

(57) ABSTRACT

A system for pressure relief for a fluid is disclosed. The system includes a storage tank, a pump assembly in an interior of the storage tank, and a pressure relief member located adjacent to the pump assembly, the pressure relief member having a first end and a second end, the first end having a first width and the second end having a second width larger than the first width, the first end located proximate to the pump assembly.

### INTRODUCTION

The present invention relates generally to a storage vessel for a fluid, and more specifically, to a device for relieving pressure in the vessel upon freezing of the liquid.

Automotive applications often include systems in which a supply of fluid is contained within a tank or vessel. However, damage may result to the tank or to pumping assemblies contained within the tank when the fluid freezes. For example, automotive applications that employ diesel exhaust fluid (DEF) systems for the reduction of NOx may carry a supply of DEF in a tank that is fluidly connected via a supply system to the diesel engine exhaust system. A challenge in the design of these systems is that DEF tends to freeze around −11 degrees centigrade (−11° C.) which is well above the minimum operable temperature of the vehicle. Freezing of the DEF in the DEF tank may be driven in part by the thermal mass of the in-tank DEF pump assembly, resulting in the final fluid portion of the tank residing above or adjacent to the pump assembly. As the final fluid portion freezes, the DEF experiences an expansion rate of about 10% which results in the application of significant forces on the pump assembly. Damage may result.

It is desirable to provide a system that avoids the damaging force that may result when fluid freezing occurs at low operating temperatures.

### SUMMARY

Embodiments according to the present disclosure provide a number of advantages. For example, embodiments according to the present disclosure protect a fluid vessel from damage due to freezing of the liquid contents.

In one aspect, a system for pressure relief for a fluid includes a storage tank, a pump assembly in an interior of the storage tank, and a pressure relief member located adjacent to the pump assembly, the pressure relief member having a first end and a second end, the first end having a first width and the second end having a second width larger than the first width, the first end located proximate to the pump assembly.

In some aspects, the pressure relief member is a cone. In some aspects, the pressure relief member is a trapezoidal prism. In some aspects, the storage tank is a diesel exhaust fluid storage tank.

In some aspects, the system further includes at least one securing member configured to secure the pressure relief member within the storage tank. In some aspects, the at least one securing member is a strut.

In another aspect, an automotive vehicle includes a storage tank, a pump assembly in an interior of the storage tank, a fluid channel fluidly connected to the storage tank, and a pressure relief member located adjacent to the pump assembly, the pressure relief member having a first end and a second end, the first end having a first width and the second end having a second width larger than the first width, the first end located proximate to the pump assembly.

In some aspects, the fluid channel is a pressurized fluid supply line. In some aspects, the pressure relief member is a cone. In some aspects, the pressure relief member is a trapezoidal prism. In some aspects, the storage tank is a diesel exhaust fluid storage tank.

In some aspects, the automotive vehicle further includes at least one securing member configured to secure the pressure relief member within the storage tank and wherein the at least one securing member is a spring strap.

In yet another embodiment, a system for diesel exhaust fluid (DEF) pressure relief for a vehicle includes a diesel exhaust fluid (DEF) storage tank, the tank having a plurality of side walls connecting a top and a bottom, a pump assembly in an interior of the DEF storage tank, a pressure relief member located adjacent to the pump assembly, the pressure relief member having a first end and a second end, the first end having a first width and the second end having a second width larger than the first width, the first end located proximate to the pump assembly, and at least one securing member connected to the pressure relief member and the tank.

In some aspects, the pressure relief member is a contraction pipe. In some aspects, the pressure relief member is a cone. In some aspects, the pressure relief member is a trapezoidal prism. In some aspects, the at least one securing member is a spring strap.

### BRIEF DESCRIPTION OF THE DRAWINGS

The present disclosure will be described in conjunction with the following figures, wherein like numerals denote like elements.

FIG. 1A is a schematic diagram of a first step in a freezing sequence of fluid in a tank, such as diesel exhaust fluid, according to an embodiment.

FIG. 1B is a schematic diagram of a second step in a freezing sequence of fluid in a tank, such as diesel exhaust fluid, according to an embodiment.

FIG. 1C is a schematic diagram of a third step in a freezing sequence of fluid in a tank, such as diesel exhaust fluid, according to an embodiment.

FIG. 2 is a partial schematic view of a vehicle including a fluid pressure relief member, according to an embodiment.

FIG. 3 is a schematic view of a fluid pressure relief member, according to an embodiment.

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through the use of the accompanying drawings. Any dimensions disclosed in the drawings or elsewhere herein are for the purpose of illustration only.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Certain terminology may be used in the following description for the purpose of reference only, and thus are not intended to be limiting. For example, terms such as “above” and “below” refer to directions in the drawings to which reference is made. Terms such as “front,” “back,” “left,” “right,” “rear,” and “side” describe the orientation and/or location of portions of the components or elements within a consistent but arbitrary frame of reference which is made clear by reference to the text and the associated drawings describing the components or elements under discussion. Moreover, terms such as “first,” “second,” “third,” and so on may be used to describe separate components. Such terminology may include the words specifically mentioned above, derivatives thereof and words of similar import.

Damage to fluid tanks and vessels can occur when the liquid freezes and exerts pressure on the vessel. The pressure of the frozen fluid can result in structural damage to the tank, such as bulging and cracking, and damage to components housed within the tank, such as sensors, pump components, tubes, etc. In the following embodiments, a pressure relief member for a diesel exhaust fluid (DEF) system is discussed as an exemplary embodiment. However, the pressure relief member discussed below may be used for any type of fluid storage system subject to freezing temperatures, such as a water tank, fuel tank, etc.

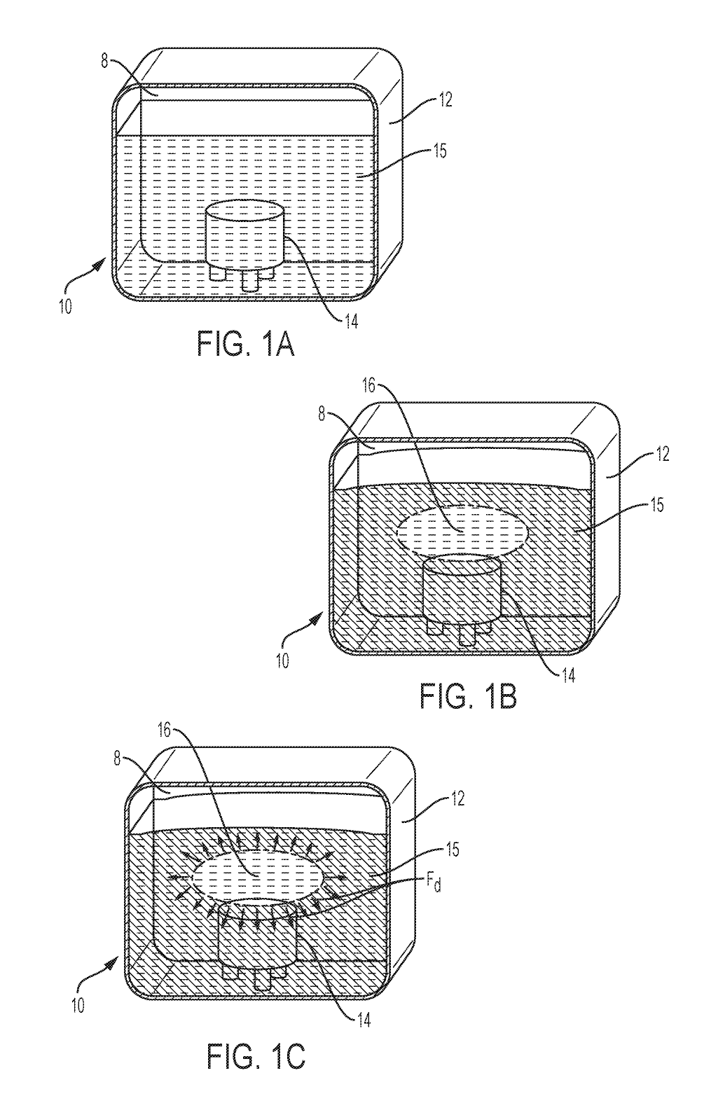

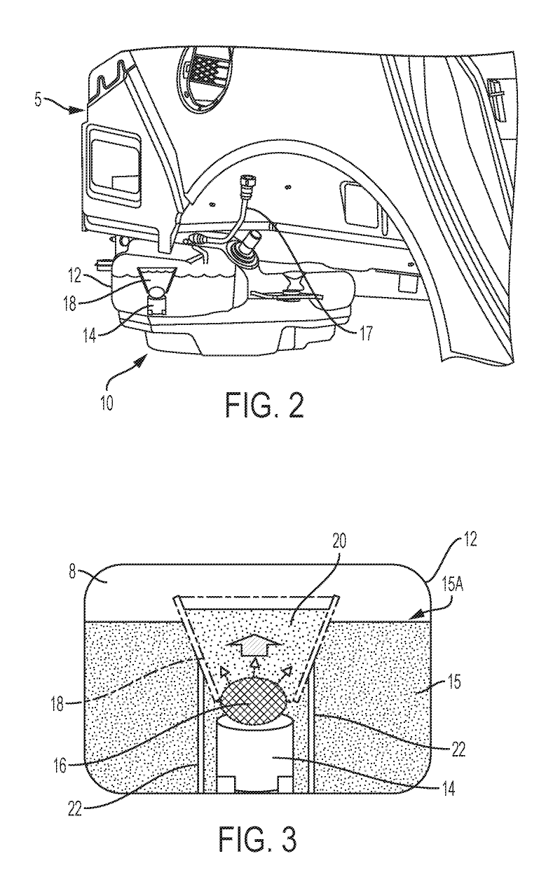

FIGS. 1A-C illustrate a diesel exhaust fluid (DEF) system 10 that may be installed in a vehicle having a diesel-type internal combustion engine (not shown), experiencing a freezing sequence of diesel exhaust fluid (DEF) or fluid 15. The system 10 includes a DEF storage tank 12 having a pump assembly 14 disposed therein. In some embodiments, automotive applications that employ DEF systems for the reduction of NOx carry a supply of fluid 15 in the storage tank 12. The fluid 15 may be fluidly connected, via a supply system (not shown), to the exhaust system of the vehicle (not shown). In some embodiments, an air space 8 is located within the interior of the tank 12 above the surface of the fluid 15. A challenge to some DEF systems occurs around negative 11 degrees centigrade (−11° C.), where the fluid 15 tends to freeze. The temperature −11° C. is above the minimum operable temperature of the vehicle. The fluid 15 in the storage tank 12 may freeze due to various factors. For example, the pump assembly 14 (as a thermal mass) may take longer to cool than the surrounding fluid 15 and may therefore cause the fluid proximate to the pump assembly 14 to freeze last. As shown in FIG. 1B, the fluid 15 tends to freeze starting from the exterior of the storage tank 12 to the interior of the storage tank 12. The freezing pattern may result in a fluid portion 16 residing above or closely adjacent to the pump assembly 14. As depicted in FIG. 1C, as the final fluid portion 16 freezes, the fluid can experience an expansion rate of about 10%, which can result in the application of significant forces F_{d} on the pump assembly 14. In some embodiments, it is advantageous to provide a pressure relief member configured to relieve fluid forces exerted on the pump assembly 14 components and the storage tank 12 to reduce or prevent damage to the pump assembly components and the tank. FIG. 2 depicts a vessel pressure relief member 18 (hereafter “member 18”) for the storage tank 12.

Referring now to FIG. 2, in some embodiments, a vehicle 5 includes the storage tank 12 configured to contain fluid 15. A pressurized supply line 17 supplies fluid 15 to the tank 12. In some embodiments, the tank 12 includes the pressure relief member 18 that is configured to relieve pressure due to freezing fluid 15 and reduce or prevent damage to the pump components or the storage vessel caused by pressure of the frozen liquid.

FIG. 3 illustrates the pressure relief member 18. In some embodiments, the pressure relief member 18 is one component of a fluid storage system, such as, for example and without limitation, the DEF system 10. The DEF system 10 includes the storage tank 12 and the pump assembly 14. The storage tank 12 includes a plurality of side walls connecting a top and bottom of the tank 12. The pump assembly 14 is contained within an interior area of the tank 12. The pressure relief member 18 is configured to release the pressure build up inside the fluid portion 16 during the freezing process. The pressure relief member 18 is at least partially submerged within the fluid 15 with a first or narrow end of the pressure relief member 18 oriented proximate to, above, or closely adjacent to the pump assembly 14. In some embodiments, a second, opposite, or wide end of the pressure relief member 18 extends above the surface 15A of the fluid 15 into the air space 8. The first or narrow end of the pressure relief member 18 has a width that is smaller than the width of the second, opposite or wide end of the pressure relief member 18. In some embodiments, the pressure relief member 18 is a contraction pipe. In some embodiments, the pressure relief member 18 is made from a plastic material, such as a high density polyethylene (HDPE)-type plastic. The size of the pressure relief member 18 depends on the size and shape of the tank 12 and pump assembly 14. In some embodiments, the pressure relief member 18 has a diameter at the widest end of approximately 6 inches, approximately 4 inches, or approximately 3 inches, but the diameter is not limited to these values. In some embodiments, the pressure relief member 18 has a diameter at narrow end of approximately 4 inches, approximately 2 inches, or approximately 1 inch, but the diameter is not limited to these values.

While the pressure relief member 18 is shown in FIG. 3 as a cone, the pressure relief member 18 could be an inverted trapezoidal prism or other shape having an open wide end oriented close to or above the surface 15A of the fluid 15 and an open narrow end oriented proximate to or adjacent to the pump assembly 14. In some embodiments, one or more strut members 22 connect the outer surface of the pressure relief member 18 to one or more of the side walls, bottom wall, and/or top wall of the tank 12 to stabilize and locate the pressure relief member 18 close to or adjacent the pump assembly 14. In some embodiments, the strut member 22 is any type of mechanical securing means, such as a spring strap. In some embodiments, the pressure relief member 18 is welded to the top wall of the tank 12 with one or more opening windows on the side surface portion of the pressure relief member 18 above the surface 15A of the fluid 15 (not shown in the figures).

As the fluid 15 freezes, a portion 20 of the fluid 15 surrounded by the pressure relief member 18 forms a frozen portion of fluid that is separated from the rest of the frozen fluid 15. After the portion 20 separates from main body of frozen fluid 15, the frozen portion 20 will be easily displaced in a vertical direction from the narrow end to the wide end of the pressure relief member 18. This separate frozen portion 20 is similar to a cork in a bottle and displaces to relieve the pressure inside the frozen fluid 15, similar to the action of a cork in a bottle that is pushed out of the bottle and relieves the pressure inside the bottle. In some embodiments, as the pressure builds up within the non-frozen fluid portion 16, a small pressure/force, such the force F_{d}, will push the frozen portion 20 up along the inner surface of the pressure relief member 18, relieving the pressure within the fluid 16. The relief of pressure due to the upward movement of the frozen portion 20 relieves pressure on the pump assembly 14 and the tank 12, reducing or preventing damage to the pump components and the tank from the pressure of the frozen fluid 15.

As shown in FIG. 3, the air space 8 allows the portion 20 of the fluid 15 to be displaced from the rest of the frozen fluid 15. In some embodiments, the portion 20 extends above the surface 15A of the fluid 15 and into the air space 8.

While the discussion of the pressure relief member 18 illustrates the member 18 as part of a DEF system, the pressuring relief member 18 may be used generally with any type of fluid storage system subject to freezing temperatures, such as a water tank, fuel tank, etc.

It should be emphasized that many variations and modifications may be made to the herein-described embodiments, the elements of which are to be understood as being among other acceptable examples. All such modifications and variations are intended to be included herein within the scope of this disclosure and protected by the following claims. Moreover, as should be apparent, the features and attributes of the specific embodiments disclosed herein may be combined in different ways to form additional embodiments, all of which fall within the scope of the present disclosure.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Moreover, the following terminology may have been used herein. The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” or “approximately” means that quantities, dimensions, sizes, formulations, parameters, shapes and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Numerical data may be expressed or presented herein in a range format. It is to be understood that such a range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited. As an illustration, a numerical range of “about 1 to 5” should be interpreted to include not only the explicitly recited values of about 1 to about 5, but should also be interpreted to also include individual values and sub-ranges within the indicated range. Thus, included in this numerical range are individual values such as 2, 3 and 4 and sub-ranges such as “about 1 to about 3,” “about 2 to about 4” and “about 3 to about 5,” “1 to 3,” “2 to 4,” “3 to 5,” etc. This same principle applies to ranges reciting only one numerical value (e.g., “greater than about 1”) and should apply regardless of the breadth of the range or the characteristics being described. A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives, and is not intended to limit the selection to only those listed alternatives or to only one of the listed alternatives at a time, unless the context clearly indicates otherwise.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A system for pressure relief for a fluid, comprising:
a storage tank;
a pump assembly in an interior of the storage tank; and
a pressure relief member located adjacent to the pump assembly, the pressure relief member having a first end and a second end, the first end having a first width and the second end having a second width larger than the first width, the first end located proximate to the pump assembly.

2. The system of claim 1, wherein the pressure relief member is a cone.

3. The system of claim 1, wherein the pressure relief member is a trapezoidal prism.

4. The system of claim 1, wherein the storage tank is a diesel exhaust fluid storage tank.

5. The system of claim 1, further comprising at least one securing member configured to secure the pressure relief member within the storage tank.

6. The system of claim 5, wherein the at least one securing member is a strut.

7. An automotive vehicle, comprising:
a storage tank;
a pump assembly in an interior of the storage tank;
a fluid channel fluidly connected to the storage tank; and
a pressure relief member located adjacent to the pump assembly, the pressure relief member having a first end and a second end, the first end having a first width and the second end having a second width larger than the first width, the first end located proximate to the pump assembly.

8. The automotive vehicle of claim 7, wherein the fluid channel is a pressurized fluid supply line.

9. The automotive vehicle of claim 7, wherein the pressure relief member is a cone.

10. The automotive vehicle of claim 7, wherein the pressure relief member is a trapezoidal prism.

11. The automotive vehicle of claim 7, wherein the storage tank is a diesel exhaust fluid storage tank.

12. The automotive vehicle of claim 7, further comprising at least one securing member configured to secure the pressure relief member within the storage tank and wherein the at least one securing member is a spring strap.

13. A system for diesel exhaust fluid (DEF) pressure relief for a vehicle, comprising:
a diesel exhaust fluid (DEF) storage tank, the tank having a plurality of side walls connecting a top and a bottom;
a pump assembly in an interior of the DEF storage tank;
a pressure relief member located adjacent to the pump assembly, the pressure relief member having a first end and a second end, the first end having a first width and the second end having a second width larger than the first width, the first end located proximate to the pump assembly; and
at least one securing member connected to the pressure relief member and the tank.

14. The system of claim 13, wherein the pressure relief member is a contraction pipe.

15. The system of claim 13, wherein the pressure relief member is a cone.

16. The system of claim 13, wherein the pressure relief member is a trapezoidal prism.

17. The system of claim 13, wherein the at least one securing member is a spring strap.
